(19) United States
(12) Patent Application Publication
(10) Pub. No.: US 2006/0171500 A1
(43) Pub. Date: Aug. 3, 2006

(54) Apparatus and methods for achieving redundant confinement sealing of a spent nuclear fuel canister

(75) Inventors: Charles W. Pennington, Alpharetta, GA (US); George Carver, Norcross, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: NAC International, Inc.

(21) Appl. No.: 11/034,622

(22) Filed: Jan. 13, 2005

(51) Int. Cl. G21C 19/00

(52) U.S. Cl. 376/272

(57) ABSTRACT

Disclosed are the apparatus and methods for closing a canister that stores and transports spent nuclear fuel. In one embodiment, the canister includes a canister shell that includes an open end. A closure lid is inserted within the open end of the canister shell. The closure lid engages the open end of the canister shell to provide a weld area that is substantially on the outer circumference of the closure lid. The weld area includes a first weld layer and a second weld layer. The first weld layer welds the closure lid to the canister shell at the weld area and closes the canister. The second weld layer also welds the closure lid to the canister shell at the weld area, providing a redundant closure seal, and is disposed substantially on top of the first weld layer. The method for closing the canister is provided herein.

### TECHNICAL FIELD

The present invention relates to a canister that stores and transports spent nuclear fuel, and more importantly, the embodiments relate to the apparatus and methods for achieving redundant confinement sealing of a canister.

### BACKGROUND OF THE DISCLOSURE

Dry nuclear spent fuel storage technology is deployed throughout the world to expand the capabilities of nuclear power plants to discharge and store spent fuel, thereby extending the operating lives of the power plants. Two fundamental classes of technology are used in dry spent fuel storage: metal casks with final closure lids that are bolted closed at the power plants after loading with spent fuel, and concrete storage casks containing metal canisters having canister final closure lids that are welded closed at the power plants following spent fuel loading. This latter technology is referred to as canister-based dry spent fuel storage technology.

Canister-based dry spent fuel storage technology designs typically comply with federal regulatory requirements, among which are requirements pertaining to confinement, sealing, inspection, and evaluation or testing. In particular, the Code of Federal Regulations (CFR) requires that “[t]he spent fuel storage cask must be designed to provide redundant sealing of confinement systems.” See 10CFR72.236(e). The confinement system is defined in 10CFR72.3, as follows: “Confinement systems means those systems, including ventilation, that act as barriers between areas containing radioactive substances and the environment.” In other words, the confinement system is the boundary that is to be protected to assure that there is no release to the environment of the contained radioactive materials within the spent fuel dry storage system.

The Nuclear Regulatory Commission (NRC), which enforces compliance with federal regulations, has applied the above requirements to fabrication facility-installed, confinement system welds in canister-based dry storage designs (those which are performed prior to delivery to the power plant and prior to loading with spent fuel) such that single or multi-pass welds that are inspected with NRC approved inspection methods and techniques meet the requirements of 10CFR72.236(e). However, for final closure welds on canister-based technology, which are conducted at nuclear facilities following loading of spent fuel, the application of the regulatory requirements has varied, but NRC approval of the varied approaches has been consistent with the use of approved single or multi-pass welding approaches followed by the application of approved inspection methods and techniques.

Over the years, most canister-based dry storage designs have followed a path to assure compliance with redundant sealing requirements for the final canister closure at the power plant (the “field closure”) by the use of redundant lids for the final closure design. That is, two lids or closures were placed within the canister and welded to the canister shell. These lids were not required to be structurally separate (independent) and could be linked to each other by additional welding. However, approaches with and without structural independence of the redundant lids have all been approved by the NRC for compliance with federal requirements.

The use of a redundant lid approach on canister-based designs leads to lid handling and installation complexities at power plants. With multiple lid handling operations, opportunities for operator injury and equipment damage are increased, and more time must be spent in higher radiation fields. Further, the use of redundant lids increases the radiation exposure of power plant personnel when compared to a single lid approach, since more time is required to handle, lift, install and weld two lids, because the first lid to be welded of a redundant lid design provides less radiation shielding to the operators, and, therefore, more radiation exposure. Such an approach may be at variance with federal regulatory requirements, if there is a reasonable alternative that reduces direct radiation levels, to wit: “Operational restrictions must be established to meet as low as reasonably achievable [known as ALARA in industry parlance, a design objective to keep operator radiation exposures reasonably low] objectives for radioactive materials in effluents and direct radiation levels associated with ISFSI or MRS operations.” (See 10CFR72.104(b).)

Thus, a heretofore unaddressed need exists in the industry to improve upon the aforementioned deficiencies and inadequacies.

### SUMMARY OF THE DISCLOSURE

Disclosed are the apparatus and methods for closing a canister that stores and transports spent nuclear fuel.

In one embodiment, a method for closing a canister includes providing a canister shell that includes an open end and providing a weld area that is substantially on the outer circumference of the closure lid where the closure lid engages the open end of the canister shell. The method further includes welding the closure lid to the canister shell at the weld area that forms a first weld layer to close the canister and welding the closure lid to the canister shell at the weld area that forms a second weld layer substantially on top of the first weld layer to close the canister.

As a further option, the method can further include welding of the closure lid to the canister shell at the weld area to form additional redundant weld layers and close the canister to assure that the composite weld layer depth and/or the number of redundant seal weld layers is achieved. As another further option, the method includes disposing a seal ring substantially above a preceding weld layer and between the canister shell and the closure lid. The method includes cooling the first, second and additional weld layers below the material-specific adhesion temperature after each layer is applied to assure the weld layers have achieved adhesion characteristics with the canister shell and closure lid, and inspecting the first, second and additional weld layers after each layer is cooled using approved methods and techniques, for example, dye-penetrant examination of the weld, to determine the quality of the weld layers and their acceptability.

In one embodiment, the canister includes a canister shell that includes an open end and a basket assembly that is disposed in the canister shell. A closure lid is inserted within the open end of the canister shell. The closure lid engages the open end of the canister shell to provide a weld area that is in the proximity of the outer circumference of the closure lid. The weld area includes a first weld layer and a second weld layer. The first weld layer welds the closure lid to the canister shell at the weld area and closes the canister. The second weld layer also welds the closure lid to the canister shell at the weld area, providing a redundant closure seal, and is disposed substantially on top of the first weld layer.

As a further option, the canister can include additional redundant weld layers that weld the closure lid to the canister shell at the weld area and that close the canister to assure that the composite weld layer depth and/or the number of redundant seal weld layers is achieved. As another further option, a seal ring is disposed substantially above a preceding weld layer and between the canister shell and the closure lid. The seal ring is welded to the closure lid and to the canister shell, providing another level of redundant closure sealing.

Other apparatus, methods, features, and advantages of the present invention will be or become apparent to one with skill in the art upon examination of the following drawings and detailed description. It is intended that all such additional apparatus, methods, features, and advantages be included within this description, be within the scope of the present invention, and be protected by the accompanying claims.

### BRIEF DESCRIPTION OF THE DRAWINGS

The disclosed systems, apparatuses, and methods can be better understood with reference to the following drawings. The components in the drawings are not necessarily to scale.

FIG. 1 is a partially cut-away, perspective view of an embodiment of a canister that stores and transports nuclear spent fuel.

FIG. 2 is a partially cut-away, cross-sectional, side view of an embodiment of the canister shown in FIG. 1.

FIGS. 3A-C are flow diagrams that illustrate an embodiment of operation of closing the canister with a single lid having redundant seals shown in FIGS. 1 and 2.

### DETAILED DESCRIPTION OF THE PREFERRED EMBODIMENT

Disclosed are apparatus and methods for a canister that stores and transports spent nuclear fuel. In one embodiment, the canister includes a weld area that includes a first weld layer and a second weld layer. The first weld layer welds a closure lid to a canister shell at the weld area and closes the canister. The second weld layer also welds the closure lid to the canister shell at the weld area, providing a redundant closure seal, and is disposed substantially on top of the first weld layer. As a further option, additional weld layers can be welded at the weld area to close the canister. As another further option, the canister can include a seal ring that is disposed substantially above a preceding weld layer and between the canister shell and the closure lid. The seal ring is welded to the closure lid and to the canister shell. The disclosed process assures that the closure lid is sealed to be leak tight. Example apparatuses are first discussed with reference to the figures. Although the apparatuses are described in detail, they are provided for purposes of illustration only and various modifications are feasible. After the exemplary apparatuses have been described, examples of methods of closing the canister are provided.

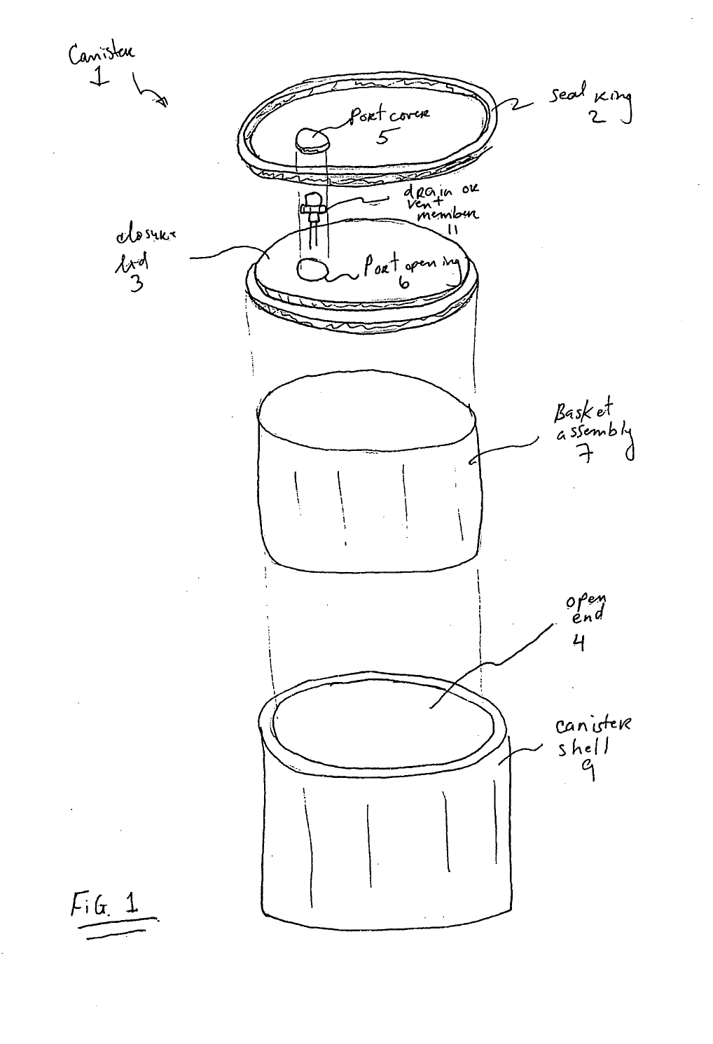

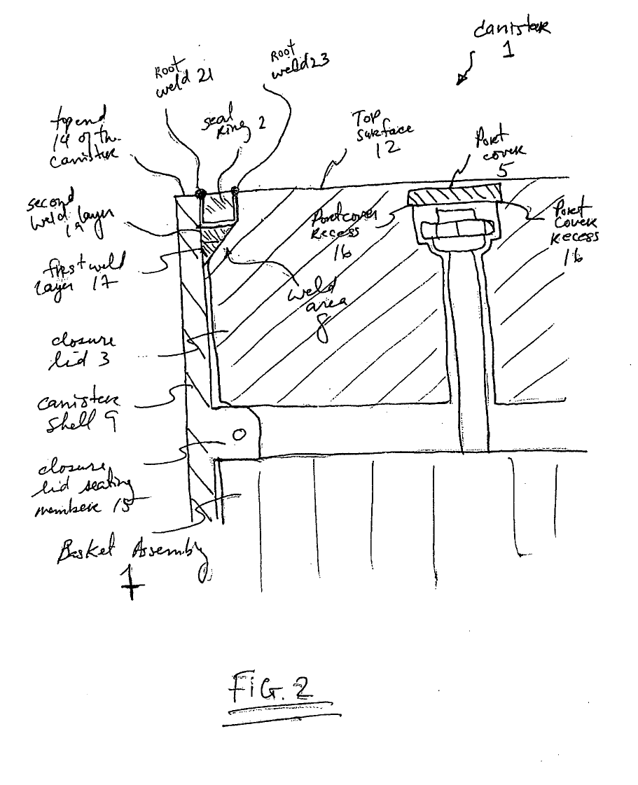

Referring now in more detail to the figures in which like reference numerals identify corresponding parts, FIG. 1 is a partially cut-away, perspective view of an embodiment of a canister that stores and transports nuclear spent fuel. The canister 1 is a single closure lid design of a canister-based dry storage technology. The canister 1 includes one closure lid 3 and one weld area 8 (shown in FIG. 2). The use of a single closure lid design is one approach to achieving redundant sealing of the confinement system for “field closure” of the canister 1 following loading with spent fuel or other desired content. The canister 1 includes a canister shell 9 that includes an open end 4. In an alternative embodiment, the closure lid 3 can include a port opening 6 that is adapted to receive a port cover 5 and a drain or vent member 11. In an alternative embodiment, the canister 1 can include a basket assembly 7 that is preferably disposed in the canister shell 9 before the canister is sealed. In an alternative embodiment, the canister 1 can further include a seal ring 2 that is disposed between the canister shell 9 and the closure lid 3, at the inner circumference of the canister shell 9 and at the outer circumference of the closure lid 3. The seal ring 2 can be a single piece or multiple pieces.

FIG. 2 is a partially cut-away, cross-sectional, side view of an embodiment of the canister shown in FIG. 1 that includes a redundant seal for regulatory compliance. The canister shell 9 of the canister 1 includes a closure lid seating member 15 that can be integrally coupled to the canister shell. The canister 1 is adapted to be inserted with a closure lid 3 that rests on the closure lid seating member 15 of the canister 1 such that the top surface 12 of the closure lid 3 is substantially parallel to the top end 14 of the basket assembly 7.

In an alternative embodiment, the closure lid seating member 15 can be integrally coupled to other internal appurtenance, such as the basket assembly 7. In an alternative embodiment, the closure lid 3 is adapted to be inserted with a drain or vent member 11 and a port cover 5. The closure lid 3 can include a drain or vent passage 10 in which the drain or vent member 11 is disposed. The drain or vent passage 10 is conformed substantially to the shape of the drain or vent member 11. The closure lid 3 further includes port cover recesses 16 that the port cover 5 rests on. The top surface of the port cover 5 is substantially parallel to the top surface 12 of the closure lid 3.

Where the closure lid 3 engages the open end 4 of the canister shell 9, a weld area 8 is provided in the proximity of the outer circumference of the closure lid 3 that meets the weld depth and weld type requirements of both the design and applicable regulations, codes and standards. A first weld layer 17 welds the closure lid 3 to the canister shell 9 at the weld area 8 and closes the canister 1 as a first seal or closure to the canister 1. A second weld layer 19 welds the closure lid 3 to the canister shell 9 at the weld area 8 and closes the canister as second seal or closure to the canister 1. The second weld layer is disposed substantially on top of the first weld layer 17. The first and second weld layers 17, 19 are independent layers and seals for the canister closure. The first and second weld layers 17, 19 are single pass welds or multi-pass welds with inter-pass temperatures that meet the requirement for the specific material and the welding method or application. In an alternative embodiment, additional redundant weld layers are applied to weld the closure lid 3 to the canister shell 9 at the weld area 8 and close the canister 1 to assure that the composite weld layer depth and/or the number of redundant seal weld layers is achieved

The weld layers 17, 19 are achieved using a multiple independent layer, discrete redundant inspection (MILDRI) weld approach, which is used to establish the redundant sealing for the single closure lid canister design. The MILDRI weld process is performed as follows:
1. A welding machine (not shown) designed to lay weld consistent with the canister design and weld configuration is placed in position to perform the weld in the weld area 8.
2. The welding machine provides a first weld layer 17 which is comprised of a root weld. It should be noted that multiple passes may be used to achieve the first weld layer.
3. The first weld layer 17 becomes the first independent layer and first seal for the canister closure by meeting the following acceptance criteria:
   a. The first weld layer 17 has been applied as a single pass weld or as a multi-pass weld with inter-pass temperatures meeting all requirements for the specific materials and welding conditions;
   b. The first weld layer 17 meets the depth requirements that are required by safety or other analysis.
   c. The first weld layer 17 is allowed to cool below some maximum temperature (in the range of the material-specific adhesion temperature) to assure the first weld layer 17 has achieved adhesion characteristics with the canister shell 9 and closure lid 3 that are suitable for independent inspection for cracks and adhesion using approved methods and techniques;
   d. An independent inspection of the first weld layer 17 is performed using approved methods and techniques, such as dye-penetrant examination, to determine the quality of the weld and its acceptability;
   e. Any weld inconsistencies, flaws, or other manifestations of lack of adhesion or weld soundness in the first weld layer 17 are reviewed, accepted, or repaired in accordance with design and procedure acceptance criteria;
   f. Any weld repairs of the first weld layer 17 are further inspected by similar methods to verify repair acceptance in accordance with appropriate acceptance criteria.

Following completion, inspection, and acceptance of the first weld layer 17, a second weld layer 19 is applied in the weld area 8 of the closure lid 3. The second weld layer 19 is in the proximity of the outer circumference of the closure lid 3 where the closure lid 3 engages the open end 4 of the canister shell 9 and is substantially on top of the first weld layer 17. The second weld layer 19 is achieved using similar steps to those in 3a-f, as explained above, to assure that the second weld layer 19, independent inspection, and integrity requirements are met to permit the first and second weld layers 17, 19 to serve as redundant seals. In an alternative embodiment, additional weld layers can be applied to assure that the composite weld layer depth and/or the number of redundant seal weld layers is achieved using similar approaches and acceptance criteria as in step 3, explained above.

In an alternative embodiment, a seal ring 2 is disposed above a preceding weld layer and between the canister shell 9 and the closure lid 3. The seal ring 2 is substantially parallel to the top end 14 of the canister 1 and top surface 12 of the closure lid 3. The seal ring is welded to the canister shell and to the closure lid 3 to form two weld surfaces 21, 23. The first and second weld surfaces 21, 23 can be single pass welds or multi-pass welds, with inter-pass temperatures that meet the requirement for the specific material and the welding method or application. The seal ring 2 provides a separate, redundant closure surface, in addition to the closure lid 3 having other weld layers. The seal ring 2 can be of a unit design or of a segmented design to facilitate handling or placement.

The root welds 21, 23 of the seal ring 2 are achieved using the MILDRI weld process as mentioned above in reference to the weld layers 17, 19. It should be noted that single pass or multi-pass welds can be applied to assure that the composite weld depth is achieved. It should also be noted that the weld surfaces 21, 23 can have multiple weld layers.

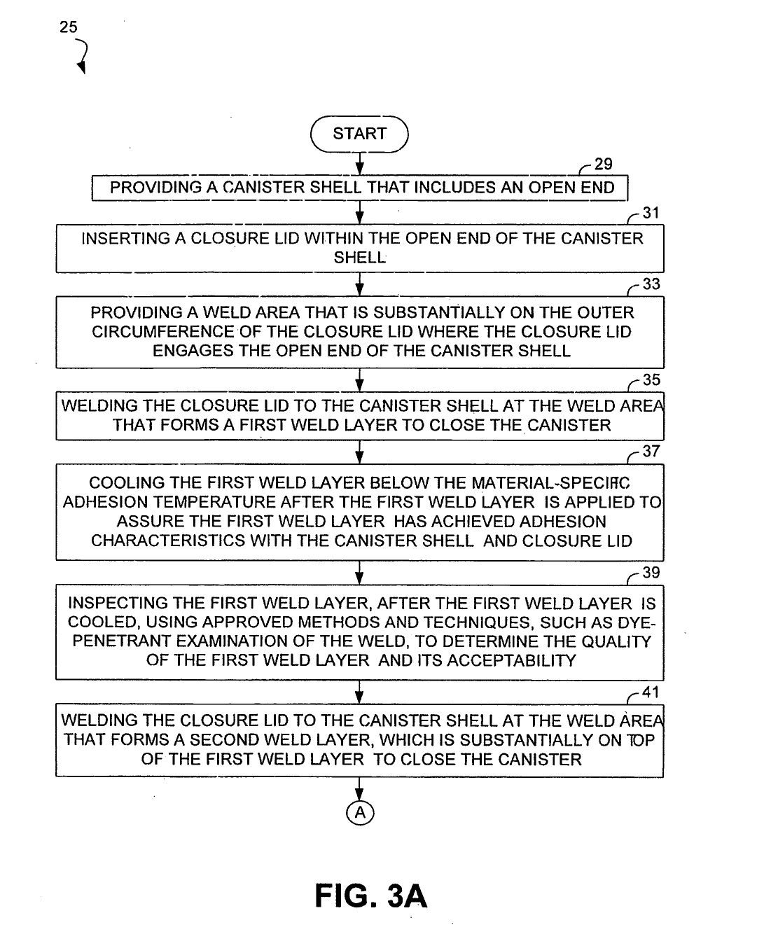

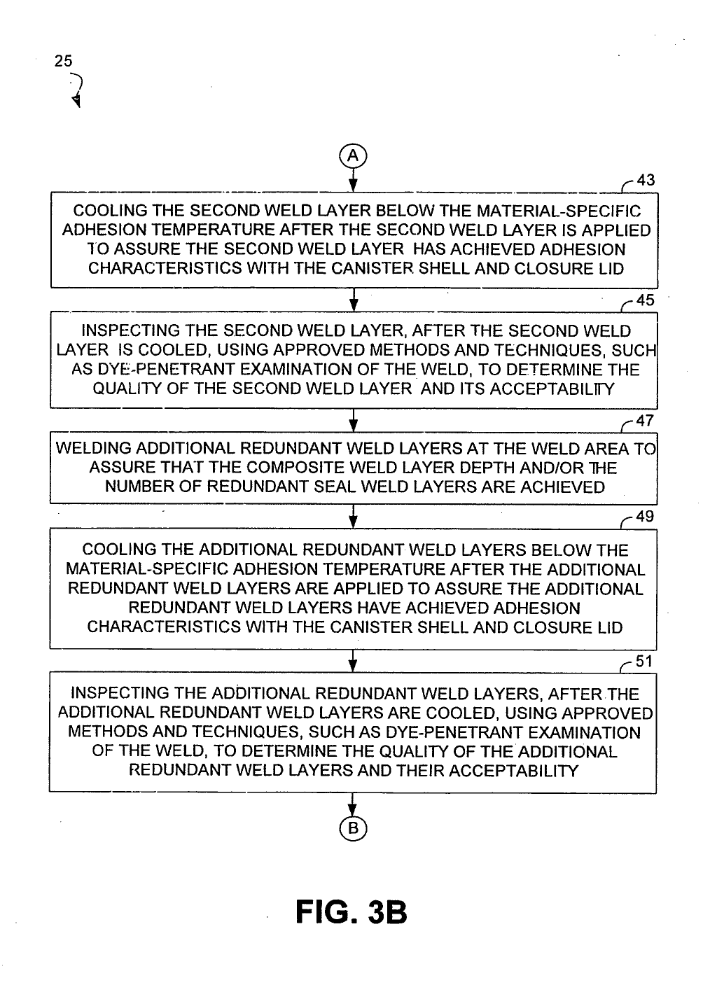

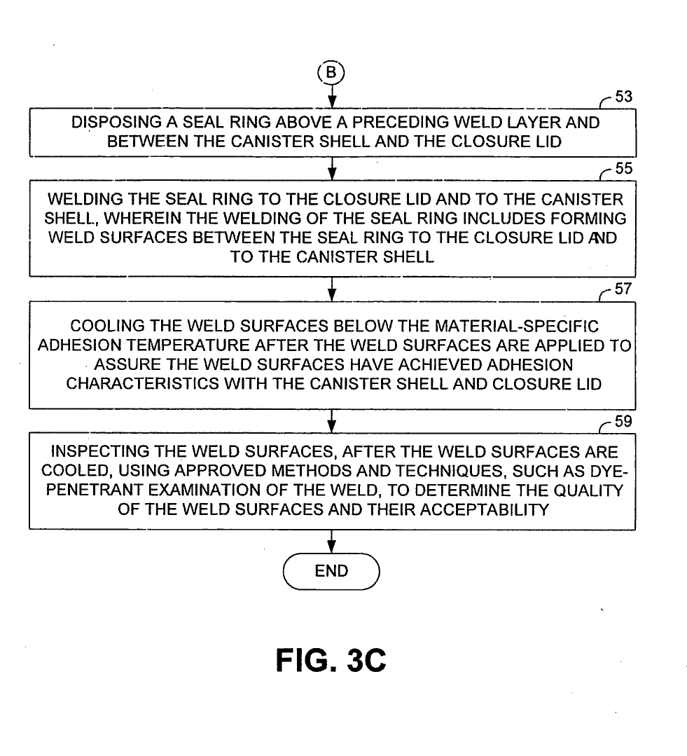

FIGS. 3A-C are flow diagrams that illustrate an embodiment of operation of closing the canister with a single lid having redundant seals shown in FIGS. 1 and 2. Referring now to FIG. 3A, in block 29, the method 25 for closing the canister 1 includes providing a canister shell 9 that includes an open end 4. In block 31, a closure lid 3 is inserted within the open end 4 of the canister shell 9. It should be noted that a basket assembly can be inserted into the canister before the closure lid 3 is inserted within the open end 4 of the canister shell 9. In block 33, a weld area 8 is provided that is substantially on the outer circumference of the closure lid 3 where the closure lid 3 engages the open end 4 of the canister shell 9.

In block 35, the closure lid 3 is welded to the canister shell 9 at the weld area 8 that forms a first weld layer 17 to close the canister 1. In block 37, the first weld layer 17 is cooled below the material-specific adhesion temperature after the first weld layer 17 is applied to assure the first weld layer 17 has achieved adhesion characteristics with the canister shell 9 and closure lid 3. In block 39, the first weld layer 17 is inspected, after the first weld layer 17 is cooled, using approved methods and techniques, such as dye-penetrant examination of the weld, to determine the quality of the first weld layer 17 and its acceptability. In block 41, the closure lid 3 is welded to the canister shell 9 at the weld area 8 that forms a second weld layer 19, which is substantially on top of the first weld layer 17 to close the canister 1.

Referring now to reference A in FIG. 3B, blocks 43 and 45 repeat steps 37 and 39 for the second weld layer 19. In block 47, additional redundant weld layers are welded at the weld area 8 to assure that the composite weld layer depth and/or the number of redundant seal weld layers are achieved. Blocks 49 and 51 repeat steps 37 and 39 for the additional weld layers. Referring now to reference B in FIG. 3C, in block 53, a seal ring is disposed above a preceding weld layer and between the canister shell 9 and the closure lid 3. In block 55, the seal ring 2 is welded to the closure lid 3 and to the canister shell 9. The welding of the seal ring 2 includes forming weld surfaces 21, 23 between the seal ring 2 to the canister shell 9 and to the closure lid 3. Weld surfaces 21, 23 can be single pass or multi-pass welds. Blocks 57 and 59 repeat steps 37 and 39 for the weld surfaces 21, 23.

It should be emphasized that the above-described embodiments of the present invention, particularly, any “preferred” embodiments, are merely possible examples of implementations, set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A canister that is capable of storing and transporting spent nuclear fuel, the canister comprising:
a canister shell that includes an open end;
a closure lid that is inserted within the open end of the canister shell;
a weld area that is in the proximity of the outer circumference of the closure lid where the closure lid engages the open end of the canister shell;
a first weld layer that welds the closure lid to the canister shell at the weld area and closes the canister; and
a second weld layer that welds the lid to the canister shell at the weld area and closes the canister, the second weld layer being disposed substantially on top of the first weld layer.

2. The canister as defined in claim 1, further comprising additional redundant weld layers that weld the closure lid to the canister shell at the weld area and closes the canister to assure that the composite weld layer depth and/or the number of redundant seal weld layers is achieved.

3. The canister as defined in claim 1, further comprising a basket assembly that is disposed in the canister shell.

4. The canister as defined in claim 2, wherein the first, second and additional weld layers are cooled below the material specific adhesive temperature after the first, second and additional weld layers are applied to assure the first, second and additional weld layers have achieved adhesion characteristics with the canister shell and closure lid.

5. The canister as defined in claim 4, wherein the first, second and additional weld layers are inspected after each layer is cooled using approved methods and techniques, such as dye-penetrant examination, to determine the quality of the weld layers and their acceptability.

6. The canister as defined in claim 1, wherein the first and second weld layers are independent layers and seals for the canister closure.

7. The canister as defined in claim 1, wherein the first and second weld layers are a single or multi-pass weld with inter-pass temperatures meeting all requirements for the specific materials and welding conditions.

8. The canister as defined in claim 2, further comprising a seal ring that is disposed substantially above a preceding weld layer and between the canister shell and the closure lid, wherein the seal ring is welded to the closure lid and to the canister shell.

9. The canister as defined in claim 8, further comprising weld surfaces that weld the seal ring to the closure lid and to the canister shell.

10. The canister as defined in claim 9, wherein weld surfaces are applied as single pass welds or multi-pass welds with inter-pass temperatures meeting all requirements for the specific materials and welding conditions.

11. The canister as defined in claim 9, wherein the weld surfaces are cooled below the material specific adhesive temperature after the weld surfaces are applied to assure the weld surfaces have achieved adhesion characteristics with the seal ring, canister shell and closure lid.

12. The canister as defined in claim 11, wherein the weld surfaces are inspected after the weld surfaces are cooled using approved methods and techniques, such as dye-penetrant examination, to determine the quality of the weld surfaces and their acceptability.

13. A method for closing a canister with a single lid having redundant seals, the method comprising:
providing a canister shell that includes an open end;
inserting a closure lid within the open end of the canister shell;
providing a weld area that is substantially on the outer circumference of the closure lid where the closure lid engages the open end of the canister shell;
welding the closure lid to the canister shell at the weld area that forms a first weld layer to close the canister; and
welding the closure lid to the canister shell at the weld area that forms a second weld layer substantially on top of the first weld layer to close the canister.

14. The method as defined in claim 13, further comprising disposing a basket assembly in the canister shell.

15. The method as defined in claim 13, further comprising welding the closure lid to the canister shell at the weld area that form additional redundant weld layers and closes the canister to assure that the composite weld layer depth and/or the number of redundant seal weld layers are achieved.

16. The method as defined in claim 15, further comprising cooling the first, second and additional weld layers below the material-specific adhesion temperature after the each layer is applied to assure the weld layers have achieved adhesion characteristics with the canister shell and closure lid.

17. The canister as defined in claim 16, further comprising inspecting the first, second and additional weld layers after each layer is cooled using approved methods and techniques, such as dye-penetrant examination, to determine the quality of the weld layers and their acceptability.

18. The method as defined in claim 15, further comprising:
disposing a seal ring substantially above a preceding weld layers and between the canister shell and the closure lid; and
welding the seal ring to the closure lid and to the canister shell.

19. The method as defined in claim 18, wherein the welding of the seal ring comprises forming weld surfaces between the seal ring to the closure lid and to the canister shell.

20. The method as defined in claim 19, further comprising cooling the weld surfaces below the material-specific adhesion temperature after the weld surfaces are applied to assure the weld surfaces have achieved adhesion characteristics with the seal ring, canister shell and closure lid.

21. The method as defined in claim 20, further comprising inspecting the weld surfaces after the weld surfaces are cooled using approved methods and techniques, such as dye-penetrant examination, to determine the quality of the weld surfaces and their acceptability.
